(19) United States
(12) Patent Application Publication
(10) Pub. No.: US 2019/0257762 A1
(43) Pub. Date: Aug. 22, 2019

(54) DETECTION DEVICE

(71) Applicant: CHROMA ATE INC., Taoyuan City (TW)

(72) Inventors: Shih-Yao PAN, Taoyuan City (TW); Szuyen LIN, Taoyuan City (TW)

(21) Appl. No.: 16/256,578

(22) Filed: Jan. 24, 2019

(30) Foreign Application Priority Data
Feb. 22, 2018 (TW) 107105875

(51) Int. Cl. G01N 21/88; G01N 21/956

(52) U.S. Cl. CPC G01N 21/8806; G01N 21/95607

(57) ABSTRACT

A detection device, applied to detect an object under test, includes a beam splitter, a pattern beam generator, an image-capturing device and a processor. The pattern beam generator and the image-capturing device are located to two different sides of the beam splitter in a conjugate arrangement. The pattern beam generator is to generate a preset pattern, and the preset pattern is then projected onto the object under test via the beam splitter. The image-capturing device is to capture a real pattern via the beam splitter, in which the real pattern is generated on the object under test after the preset pattern is projected onto the object under test. The processor is to compare the preset pattern and the real pattern and to further determine a quality of the object under test.

This application claims the benefit of Taiwan Patent Application Serial No. 107105875, filed on Feb. 22, 2018, the subject matter of which is incorporated herein by reference.

### BACKGROUND OF THE INVENTION

### 1. Field of the Invention

The invention relates to a detection device, and more particularly to a detection device that is conjugately arranged.

### 2. Description of the Prior Art

Nowadays, applications of smart phones are versatile and blooming, such as news reading, community website activities and gaining Actually, activities over smart phones have become one of important elements in people's ordinary life. In particular, one of important components in the smart phone is the battery. The battery for smart phones can be largely grouped into a built-in battery or a replaceable battery. The built-in battery is usually seen in a smart phone that does not provide a detachable back cover for replacing or accessing the battery. Thus, the smart phone can be made much thinner. On the other hand, the smart phone furnished with the replaceable battery usually has a piece of back cover to be removable for replacing the battery.

No matter what type of the smart phone is, the battery shall be inspected prior before a corresponding shipment can be made by the manufacturer. Through the prior-shipment inspection, defected batteries can be picked out. While in manufacturing a typical battery, an outer shell is usually vacuumed to wrap or package a battery core. In the case that the battery is inflated or has a worn shell, then the appearance of the battery would be uneven. Unevenness to the appearance of the battery is highly related a defected or no-good battery. In the art, a coaxial or annular illuminating method is usually applied to inspect the appearance of the battery. However, in this conventional method, the resulted image contrast is low, and thus the yield of inspection is fluctuating.

### SUMMARY OF THE INVENTION

Accordingly, it is an object of the present invention to provide a detection device that can improve the image contrast and the yield of inspection in comparison with the conventional coaxial or annular illuminating method.

In the present invention, the detection device, applied to detect an object under test, includes a beam splitter, a pattern beam generator, an image-capturing device and a processor. The pattern beam generator and the image-capturing device are located to two different sides of the beam splitter in a conjugate arrangement. The pattern beam generator is to generate a preset pattern, and the preset pattern is then projected onto the object under test via the beam splitter. The image-capturing device is to capture a real pattern via the beam splitter, in which the real pattern is generated on the object under test after the preset pattern is projected onto the object under test. The processor is to compare the preset pattern and the real pattern and to further determine a quality of the object under test.

By providing the aforesaid detection device, since the pattern beam generator and the image-capturing device are in a conjugate arrangement, thus the proportionality and the contrast of the real pattern would be better matched with the preset pattern. Thereupon, the image contrast of the real pattern can be improved, the detection stability of the object under test can be ensured, and the inspection quality of the detection device can be enhanced.

In addition, since the distance between the pattern beam generator and the beam splitter is equal to that between the imaging surface of the image-capturing device and the beam splitter, thus variables to affect the detection stability can be further reduced. Thus, the inspection quality of the detection device can be substantially assured.

All these objects are achieved by the detection device described below.

### BRIEF DESCRIPTION OF THE DRAWINGS

The present invention will now be specified with reference to its preferred embodiment illustrated in the drawings, in which:

FIG. 1 is a schematic view of a first embodiment of the detection device in accordance with the present invention;

FIG. 2 is a schematic view of the grating of FIG. 1;

FIG. 3 is a photo of a preset pattern generated by the pattern beam generator of FIG. 1;

FIG. 4 is a photo of a real pattern captured by the image-capturing device of FIG. 1;

FIG. 5 is a schematic view of the vectorized preset pattern and the vectorized real pattern of FIG. 1; and

FIG. 6 is a schematic view of a grating of a second embodiment of the detection device in accordance with the present invention.

### DESCRIPTION OF THE PREFERRED EMBODIMENT

The invention disclosed herein is directed to a detection device. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

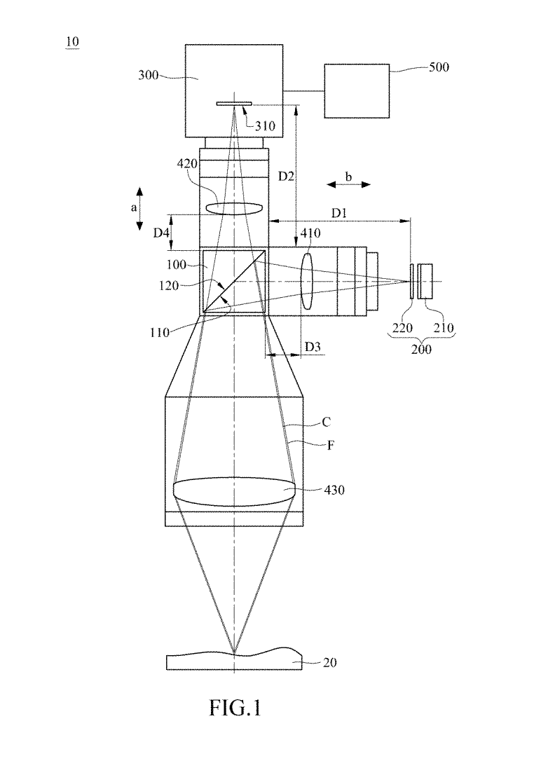

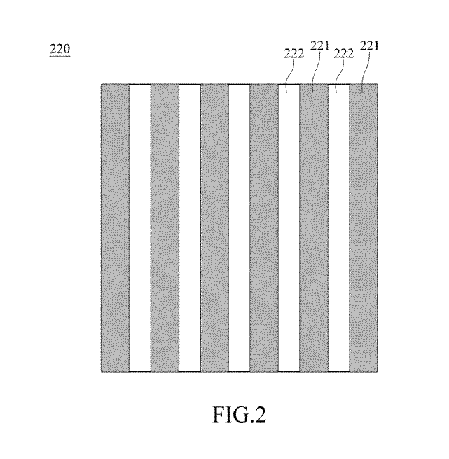

Refer now to FIG. 1 and FIG. 2; where FIG. 1 is a schematic view of a first embodiment of the detection device in accordance with the present invention, and FIG. 2 is a schematic view of the grating of FIG. 1.

In this embodiment, the detection device 10 is applied to detect an object under test 20 such as a lithium battery. Typically, while in manufacturing the lithium battery, a vacuum technique would be introduced to make an outer shell wrap or package a battery core. Normally, if the battery core is not inflated, and/or if the outer shell for packaging the battery core is not worn, then the packaged battery would have a smooth external surface. Otherwise, the packaged battery would have an uneven surface.

The detection device 10 includes a beam splitter 100, a pattern beam generator 200, an image-capturing device 300 and a processor 500.

The beam splitter 100 includes an interface providing two opposite surfaces, i.e., a first surface 110 and a second surface 120. The interface, including the first surface 110 and the second surface 120, is slantingly arranged. Preferably, the interface has a 45-degree slope. In particular, as shown, the first surface 110 faces down right, while the second surface 120 faces up left. In the case that a light beam travels in a direction a to hit the first surface 110 or the second surface 120, the light beam would penetrate directly the interface (i.e., the first surface 110 and the second surface 120) without any deflection. On the other hand, in the case that a light beam travels in a direction b to hit the first surface 110 or the second surface 120, then the light beam would be reflected by the first surface 110 or the second surface 120, respectively.

The pattern beam generator 200 and the image-capturing device 300 are located to different sides of the beam splitter 100, preferably in a conjugate arrangement. In one exemplary example, the pattern beam generator 200 can be disposed to a right side of the beam splitter 100, while the image-capturing device 300 is disposed above the beam splitter 100. As shown in FIG. 1, upon such an arrangement, the first surface 110 of the beam splitter 100 is facing the pattern beam generator 200, while the second surface 120 of the beam splitter 100 is facing the image-capturing device 300. Namely, the pattern beam generator 200 and the image-capturing device 300 present the conjugate arrangement. With this conjugate arrangement, an illumination range F defined by the lights irradiated by the pattern beam generator 200 and passing the beam splitter 100 would be completely overlapped with an image-capturing range C defined by the image-capturing device 300 with respect to the beam splitter 100. Details thereabout would be elucidated lately.

The pattern beam generator 200 includes a light source 210 and a grating 220. The light source 210 can be a surface-light source. The grating 220 is disposed between the light source 210 and the beam splitter 100. The grating 220 has a plurality of straight shading strips 221, substantially parallel to each other. The plurality of shading strips 221 divide the plane into a plurality of parallel light intervals 222, such that, as lights radiated by the light source 210 pass the grating 220, an image with a plurality of prolong white strips as shown in FIG. 3 can be obtained. This image of FIG. 3 is defined as a preset pattern P. In this embodiment, the preset pattern P formulated by the pattern beam generator 200 is used to project onto an object under test 20 via the beam splitter 100. In this embodiment, the preset pattern P includes periodic parallel rectangular white strips. However, in some other embodiments, the preset pattern can be non-periodic patterns.

In addition, in this embodiment, the pattern beam generator 200 is consisted of the light source 210 and the grating 220. In some other embodiments, by waiving the grating, the preset pattern can be produced simply by arranging a plurality of light sources into a specific formulation.

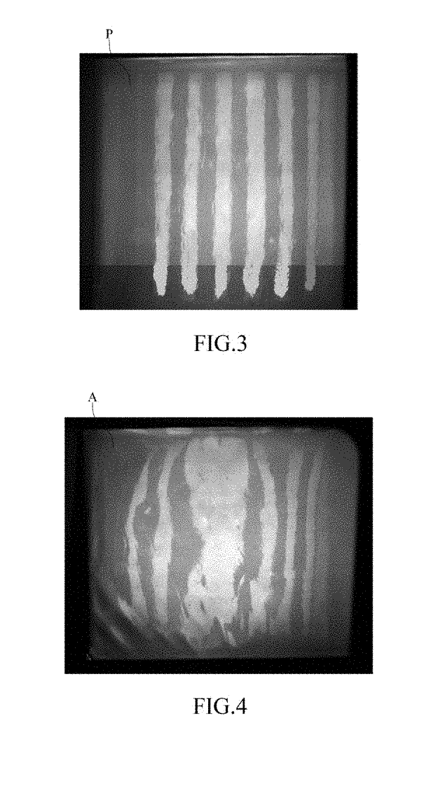

The image-capturing device 300 is used for capturing a real pattern A (see FIG. 4 for example) on the object under test 20 via the beam splitter 100, after the preset pattern P is projected onto the object under test 20. The image-capturing device 300 has an imaging surface 310 for imaging the image captured by the image-capturing device 300 thereon. In this embodiment, a distance D2 between the imaging surface 310 and the beam splitter 100 is equal to a distance D1 between the grating 220 and the beam splitter 100. Upon such an arrangement, factors influencing to the detection stability can be significantly reduced, and thus detection accuracy of the detection device 10 can be substantially increased.

The processor 500 such as a personal computer is used for comparing the preset pattern P and the real pattern A so as further to determine the production quality of the object under test 20.

In this embodiment, the detection device 10 further includes a first lens 410, a second lens 420 and a third lens 430. The first lens 410, the second lens 420 and the third lens 430 can all be convex lenses. The first lens 410, positioned between the pattern beam generator 200 and the beam splitter 100, is used for the preset pattern P formulated by the pattern beam generator 200 to be projected onto the beam splitter 100. The second lens 420, positioned between the image-capturing device 300 and the beam splitter 100, is used for the real pattern A generated by projecting the preset pattern P on the object under test 20 to travel back to the imaging surface 310 of the image-capturing device 300. In addition, the first lens 410 is the same as the second lens 420, and a distance D3 between the first lens 410 and the beam splitter 100 is equal to a distance D4 between the second lens 420 and the beam splitter 100. Upon such an arrangement, variables to affect the detection can be remarkably reduced. Namely, the detection accuracy of the detection device 10 can be further enhanced. The third lens 430 and the second lens 420 are located at two opposite sides of the beam splitter 100. Namely, the beam splitter 100 is located between the image-capturing device 300 and the third lens 430, such that the preset pattern P can focused on the object under test 20.

Referring now to FIG. 3 through FIG. 5; where FIG. 3 is a photo of a preset pattern generated by the pattern beam generator of FIG. 1, FIG. 4 is a photo of a real pattern captured by the image-capturing device of FIG. 1, and FIG. 5 is a schematic view of the vectorized preset pattern and the vectorized real pattern of FIG. 1.

For example, a defective object under test 20 is encountered during the testing, wherein the defective object under test 20 means the object under test 20 has an uneven surface. When the pattern beam generator 200 generates the preset pattern P (as shown in FIG. 3) having a plurality of parallel rectangular white strips to travel in the direction b and then to project onto the first surface 110 of the beam splitter 100, the first surface 110 of the beam splitter 100 would reflect the preset pattern P onto the uneven surface of the object under test 20. Since the preset pattern P would be effected by the uneven surface of the object under test 20, the original parallel rectangular white strips in the preset pattern P would be distorted into the real pattern A on the object under test 20 (as shown in FIG. 4), i.e., a irregular distorted pattern. Then, the real pattern A would travel back to the first surface 110 of the beam splitter 100 in the direction a, and further to project onto the imaging surface 310 of the image-capturing device 300. As shown in FIG. 5, the processor 500 would vectorize both the real pattern A and the preset pattern P to produce the vectorized real pattern V2 and the vectorized preset pattern V1, respectively. Then, the vectorized real pattern V2 and the vectorized preset pattern V1 are overlapped for comparison. In practice, each curve of the vectorized real pattern V2 would be compared with the nearest line of the vectorized preset pattern V1, and the least square method is introduced to calculate the difference between the vectorized real pattern V2 and the vectorized preset pattern V1. If the difference exceed a preset value, then the object under test 20 is determined to be “No good”. Otherwise, if the difference is less than the preset value, then the object under test 20 is determined to be qualified.

In this embodiment, since the pattern beam generator 200 and the image-capturing device 300 are conjugately arranged, thus the proportionality and the contrast of the real pattern A would be better matched with the preset pattern P. Thereupon, the image contrast of the real pattern A can be improved, the detection stability of the object under test 20 can be ensured, and the inspection quality of the detection device 10 can be enhanced.

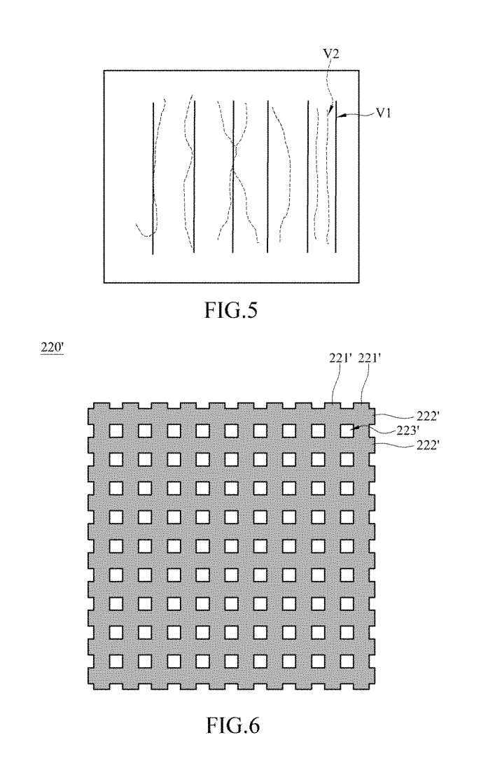

In the embodiment of FIG. 1, the grating 220 is formulated to have a plurality of parallel shading strips 221. However, in the present invention, different formulations for the grating may be also accepted. Referring now to FIG. 6, a schematic view of a grating of a second embodiment of the detection device in accordance with the present invention is shown.

In this embodiment, a grating 220′ is formulated into a grid arrangement by having a plurality of first parallel shading strips 221′ and a plurality of second parallel shading strips 222′, in which each said first shading strip 221′ is preferably perpendicular to every said second shading strip 222′. As shown, the plurality of first shading strips 221′ and the plurality of second shading strips 222′ are integrated to form a plurality of light intervals 223′, arranged in an array manner Since the grating 220′ of this second embodiment provides a 2-dimensional pattern, thus the detection accuracy of the detection device can be further increased.

By providing the aforesaid embodiments of the detection device, since the pattern beam generator and the image-capturing device are in a conjugate arrangement, thus the proportionality and the contrast of the real pattern would be better matched with the preset pattern. Thereupon, the image contrast of the real pattern can be improved, the detection stability of the object under test can be ensured, and the inspection quality of the detection device can be enhanced.

In addition, since the distance between the pattern beam generator and the beam splitter is equal to that between the imaging surface of the image-capturing device and the beam splitter, thus variables to affect the detection stability can be further reduced. Thus, the inspection quality of the detection device can be substantially assured.

While the present invention has been particularly shown and described with reference to a preferred embodiment, it will be understood by those skilled in the art that various changes in form and detail may be without departing from the spirit and scope of the present invention.

What is claimed is:

1. A detection device, applied to detect an object under test, comprising:
a beam splitter;
a pattern beam generator and an image-capturing device, located at two different sides of the beam splitter in a conjugate arrangement, wherein the pattern beam generator is to generate a preset pattern, the preset pattern is projected onto the object under test via the beam splitter, the image-capturing device is to capture a real pattern via the beam splitter, the real pattern is generated on the object under test after the preset pattern is projected onto the object under test; and
a processor, being to compare the preset pattern and the real pattern and to further determine a quality of the object under test.

2. The detection device of claim 1, wherein, after being through the beam splitter, an illumination range of the pattern beam generator is completely overlapped with an image-capturing range of the image-capturing device.

3. The detection device of claim 1, wherein a distance between the pattern beam generator and the beam splitter is equal to a distance between an imaging surface of the image-capturing device and the beam splitter.

4. The detection device of claim 3, wherein the pattern beam generator includes a light source and a grating, the grating is located between the light source and the beam splitter, and the light source emits the preset pattern via the grating.

5. The detection device of claim 4, wherein the light source is a surface light source.

6. The detection device of claim 4, wherein the grating includes a plurality of shading strips and a plurality of light intervals being separated individually by the plurality of shading strips.

7. The detection device of claim 4, wherein the grating includes a plurality of first shading strips and a plurality of second shading strips perpendicular to the plurality of first shading strips, the plurality of first shading strips and the plurality of second shading strips are integrated to form a plurality of light intervals arranged in an array manner.

8. The detection device of claim 1, further including a first lens and a second lens, wherein the first lens is located between the pattern beam generator and the beam splitter, and the second lens is located between the image-capturing device and the beam splitter.

9. The detection device of claim 8, wherein the first lens is the same as the second lens, and a distance between the first lens and the beam splitter is equal to a distance between the second lens and the beam splitter.

10. The detection device of claim 9, further including a third lens, wherein the beam splitter is located between the image-capturing device and the third lens.
